(19) United States
(12) Patent Application Publication
(10) Pub. No.: US 2002/0126064 A1
(43) Pub. Date: Sep. 12, 2002

(54) Matrix type LED wall display tube device

(75) Inventor: George Yen, Taipei (TW)

Correspondence Address: DOUGHERTY & TROXELL, SUITE 1404, 5205 LEESBURG PIKE, FALLS CHURCH, VA, 22041, US

(73) Assignee: Star-Reach Corporation

(21) Appl. No.: 09/799,676

(22) Filed: Mar. 7, 2001

(51) Int. Cl. G09G 5/00

(52) U.S. Cl. 345/5

(57) ABSTRACT

A matrix type LED wall display tube device is adapted for mounting on a wall, and includes equidistantly spaced apart LEDs soldered onto circuit boards and disposed inside transparent tubes to form serially connected display tubes. The display tubes are spaced apart and secured in juxtaposition by means of interconnected bases. A programmable controller is used to achieve LED signal displays to therbey provide a display device with advantages of good displaying effects, easy installation and low costs.

### BACKGROUND OF THE INVENTION

1. Field of the Invention

The present invention relates to a matrix type LED wall display tube device.

2. Description of the Prior Art

As LEDs have features of low power consumption, high luminosity, color purity, and can produce multifarious light source changes and dynamic lighting effects by passing electric currents and pulses through three basic colors of red, blue and green, they are widely used in all kinds of display devices, visible light projectors and building decorations, particularly on advertising walls or display devices. Since monochrome light bulbs of high-purity colors of red, blue, green and purple have been successfully developed, display devices and color projecting materials using LEDs have been feasible.

Although use of LEDs on display devices has the aforesaid advantages, LEDs are costly. Costs of disply devices or advertising walls using a large number of LEDs are especially high. This is because the LEDs used in display devices or light projecting lamps are densely arranged so that the amount of LEDs used in unit areas is inconceivably large. Thus, LED display boards and walls are very expensive and are therefore unpopular.

Aside from being costly, LED display walls are usually huge in size due to dense arrangement of the LEDs, and may block sunlight when installed on the outer walls of a building. Besides, they will alter the outer appearance of the building, and are difficult to maintain and repair. Therefore, how to reduce the costs of LED display devices, projectors and the like are problems to be resolved. However, under the circumstances that the unit price of LEDs cannot be lowered, it appears difficult to reduce the manufacturing costs.

### SUMMARY OF THE INVENTION

The primary object of the present invention is to provide a matrix type wall display tube device that overcomes the drawbacks with the prior art.

According to this invention, LEDs are arranged linearly and in paris and are inserted in or soldered to strip-like circuit boards, which are disposed inside transparent tubes. The transparent tubes can be connected in series to a desired length. The display tubes are spaced apart and secured in juxtaposition by means of interconnected bases. A programmable controller is used to achieve LED signal displays. Although the signal displaying effect does not surpass that of densely packed display device, the costs can be considerably reduced. Besides, the construction of the present invention is simple, and the size is small. It will not block out sunlight or mar the appearance of the building, and is accessible to maintenance and repair. As such, it provides another good alternative. In addition, after the display tubes are connected in series, a programmable controller can, via inputs, control the display tubes to display the desired colors and luminosity, patterns, information, etc.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of the present invention;

FIG. 2 is a perspective view showing serial connection of transparent tubes according to the present invention;

FIG. 3 is a perspective view showing assembly of the transparent tubes and bases according to the present invention;

FIG. 4 is a schematic view illustrating serial connection of the bases; and

FIG. 5 is a schematic view of a controller according to the present invention.

### DETAILED DESCRIPTION OF THE PREFERRED EMBODIMENT

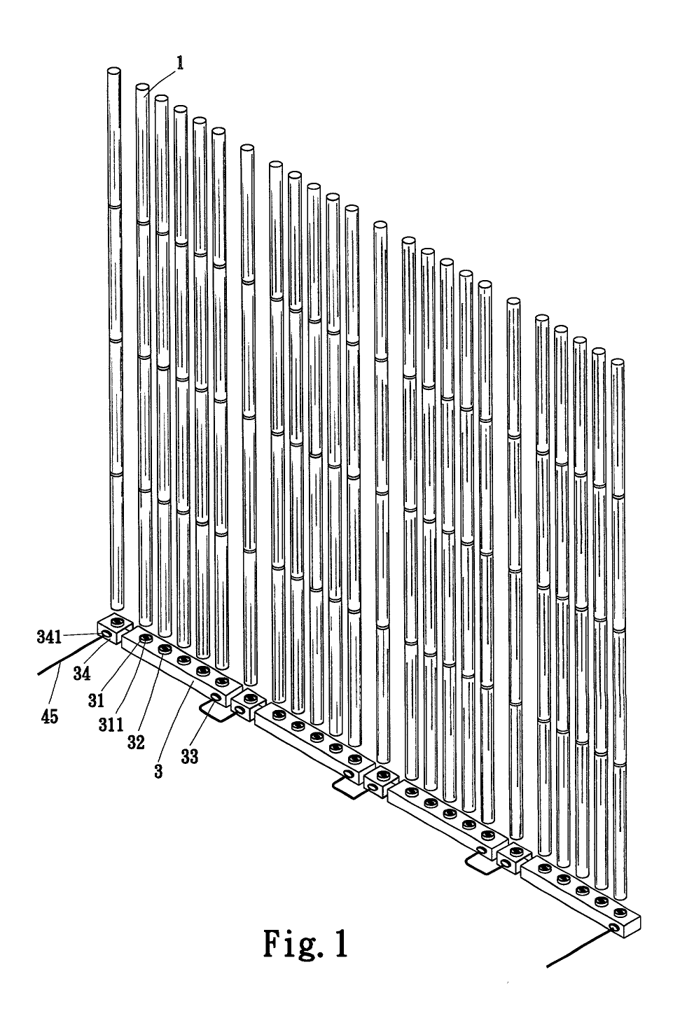

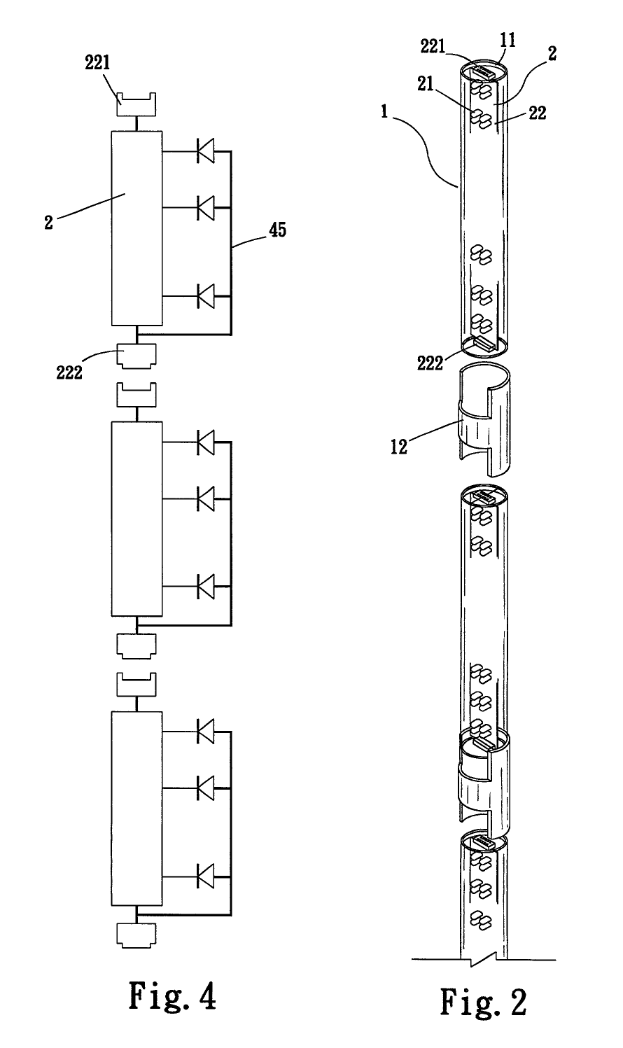

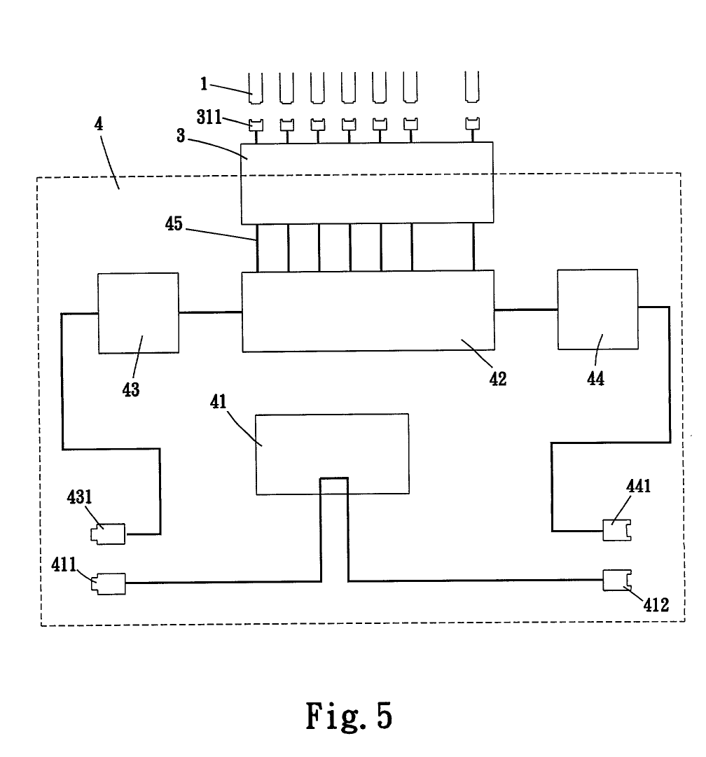

With reference to FIG. 1 and FIG. 5, the present invention includes light-emitting transparent tubes 1, LED lighting units 2, bases 3 and a controller 4. As shown in FIG. 2, the tranparent tubes 1 receive the LED lighting units 2. The LED lighting units 2 each include LED members 21 arranged linearly and in pairs and are insertably disposed or soldered to strip-like circuit boards 22. Two ends of the circuit board 22 are respectively provided with connecting terminals 221, 222. By virtue of this construction, the strip-like circuit baord 22 with the LED members 2 can be secured within the transparent tubes 11 to form light-emitting transparent tubes 1. The light-emitting transparent tubes 1 can be connected by means of coupling tubes 12 to a desired length after the connecting terminals 221, 222 are coupled.

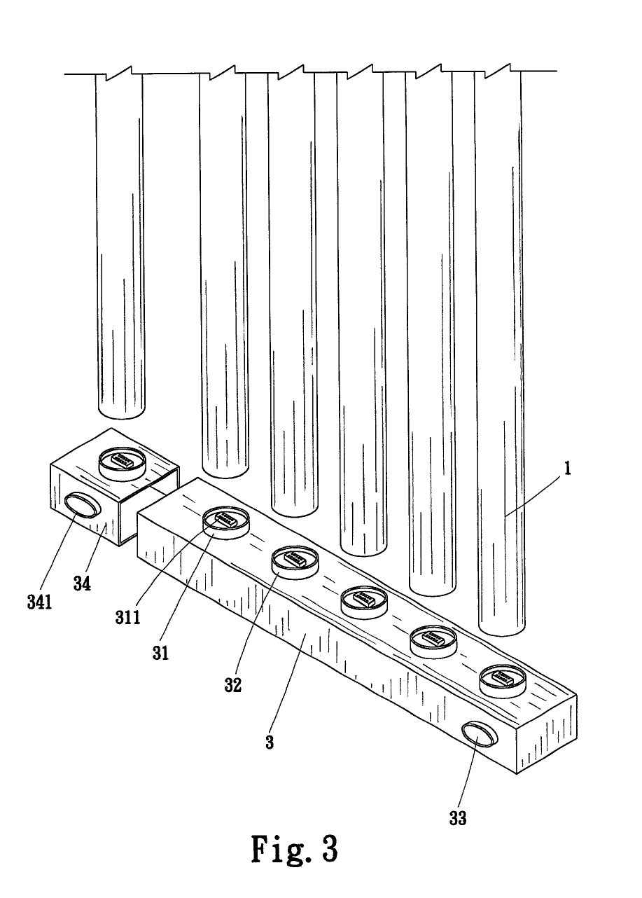

With reference to FIG. 3, the present invention includes a plurality of bases 3, each of which is provided with a plurality of equi-distantly spaced apart supporting seats 31, 32. The distance between the supporting seats 31, 32 is the distance between the light-emitting transparent tubes 1. Each support seat 31 is internally provided with connecting terminals 311 so as to be associated with the connecting terminals 222 at the bottom end of the light-emitting transparent tubes 1 when the light-emitting transparent tube 1 is disposed and secured in the support seat 31. Each base 3 may be suitably provided with bus terminals 33 for serial connection with other bases 3. If desired, connecting bases 34 having bus terminals 34 thereon can be provided to connect the bases 3 in series, as shown in FIG. 4.

With reference to FIG. 5, the controller 4 according to the present invention includes a power source unit 41, which has two polar power source ends 411, 412. The center of the controller 4 is a logic driver 42. The two ends are respectively provided with input and output buffers 43, 44, the respective connecting ends 431, 441 of which are connected to the two polar power source ends 411, 412 to make electrical connection. The logic driver 42 is connected to the bases 3 via lead wires 45. As such, the device of this invention can, via input settings and the controller 4, control the entire light emitting screen composed of the light-emitting transparent tubes 1 to exhibit the desired multifarious effects, including color changes, light changes, dynamic images, etc.

In sum, the present invention can achieve desirable LED displaying effects at relatively low costs, while being simple in construction and small in size. Besides, the present invention will not block out sunlight or mar the appearance of the building on which it is installed, and is accessible to maintenance and repair.

While the present invention has been described in connection with what is consdidered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A matrix type LED wall display tube device, including light-emitting transparent tubes, LED lighting units, bases and a controller that combine to form a tubular spaced-apart display screen.

2. The matrix type LED wall display tube device according to claim 1, wherein in said light-emitting transparent tubes and said LED lighting units, said LED lighting units include LED members arranged linearly and in pairs and are inserted in or soldered to strip-like circuit boards, said circuit boards each having two ends respectively provided with connecting terminals, said light-emitting transparent tubes including transparent tubes into which said circuit boards with said LED members are disposed.

3. The matrix type wall display tube device according to claim 1, wherein each of light-emitting transparent tubes can be connected via coupling tubes after connection of said connecting terminals so as to obtain a desired length.

4. The matrix type wall display tube device according to claim 1, wherein said light-emitting transparent tubes are secured on said bases, each of said bases being provided with equidistantly spaced apart supporting seats, each of said supporting seat being internally provided with connecting terminals so as to be connected to said connecting terminals at bottom ends of said light-emitting transparent tubes are disposed and secured in aid supporting seats, each of said bases being provided with bus terminals for serial connection with other bases; if desired, connecting bases having bus terminals thereon can be provided to achieve serial connection among said bases.

5. The matrix type wall display tube device according to claim 1, wherein said controller includes a power source unit, a logic driver, input and output buffers, said power source unit having two polar power source ends, said logic driver having two ends respectively provided with said input and output buffers, the respective connecting ends thereof being connected to said two polar power source ends to make electrical connection, said logic driver being connected to said bases via lead wires, whereby said controller can, via input settings, control the entire light emitting screen composed of said light-emitting transparent tubes.
